(19) United States
(12) Patent Application Publication
(10) Pub. No.: US 2006/0078433 A1
(43) Pub. Date: Apr. 13, 2006

(54) Sputter ion pump and manufacturing method therefor and image display device with sputter ion pump

(76) Inventors: Kazuyuki Seino, Fukaya-shi (JP); Yoshiyuki Shimada, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/281,374

(22) Filed: Nov. 18, 2005

Related U.S. Application Data
(63) Continuation of application No. PCT/JP04/07062, filed on May 18, 2004.

(30) Foreign Application Priority Data
May 20, 2003 (JP) 2003-142240
May 20, 2003 (JP) 2003-142241

(51) Int. Cl. F04B 37/02; H02K 44/00

(52) U.S. Cl. 417/50; 417/48

(57) ABSTRACT

A sputter ion pump comprises a metal pump container. In the pump container are arranged a cathode and an anode opposed to each other in the pump container and a permanent magnet situated between the cathode and the inner surface of the pump container. After locating the anode, cathode, and magnetic material in the pump container, the magnetic material is magnetized from outside the pump container, thereby forming the permanent magnet.

### CROSS REFERENCE TO RELATED APPLICATIONS

This is a Continuation Application of PCT Application No. PCT/JP2004/007062, filed May 18, 2004, which was published under PCT Article 21(2) in Japanese.

This application is based upon and claims the benefit of priority from prior Japanese Patent Applications No. 2003-142240, filed May 20, 2003; and No. 2003-142241, filed May 20, 2003, the entire contents of both of which are incorporated herein by reference.

### BACKGROUND OF THE INVENTION

1. Field of the Invention

This invention relates to a sputter ion pump, a sputter ion pump manufacturing method, and an image display device with the sputter ion pump.

2. Description of the Related Art

In recent years, various image display devices have been developed as a next generation of lightweight, thin display devices to replace cathode-ray tubes (hereinafter referred to as CRTs). These image display devices include a liquid crystal display (hereinafter referred to as an LCD), plasma display panel (hereinafter referred to as a PDP), field emission display (hereinafter referred to as an FED), surface-conduction electron emission display (hereinafter referred to as an SED), etc. In the LCD, the intensity of light is controlled by utilizing the orientation of a liquid crystal. In the PDP, phosphors are caused to glow by ultraviolet rays that are produced by plasma discharge. In the FED, phosphors are caused to glow by electron beams from field-emission electron emitting elements. In the SED, phosphors are caused to glow by electron beams from surface-conduction electron emitting elements.

In general, an FED or SED has a front substrate and a rear substrate that are opposed to each other across a given gap. These substrates constitute a vacuum envelope. The front substrate is formed with a phosphor screen, while the rear substrate is provided with a plurality of electron emitting elements for use as electron sources that excite the phosphor screen. According to the FED or SED of this type, the thickness of the display device can be reduced to several millimeters or thereabouts. When compared with a CRT that is used as a display of an existing TV set or computer, therefore, it can be made lighter and thinner, and in addition, more energy-efficient.

In order to operate the electron emitting elements more steadily in the display device described above, the interior of the envelope must be kept at a very high degree of vacuum of about 10⁻⁴ to 10⁻⁵ Pa. In the case of the PDP, moreover, it must be filled with discharge gas after it is evacuated once. Accordingly, there is disclosed a display device in which a getter is located in a vacuum envelope to maintain a high vacuum. Proposed in Jpn. Pat. Appln. KOKAI Publication No. 5-121012, for example, moreover, is a display device in which a sputter ion pump (SIP) is connected to a vacuum envelope to maintain a high degree of vacuum for a long period of time.

The SIP comprises a pump container, inside which is maintained a vacuum and connected to the display device, and a permanent magnet provided outside the pump container. A cathode and anodes are opposed to one another in the pump container. The anodes are formed of a titanium plate or the like each and provided on either side of the cathode. The permanent magnet generates a magnetic field perpendicular to the cathode.

If a high voltage of 3 to 5 kV is applied between the anodes and the cathode in a manner such that the magnetic field is applied by the magnet, electrons are shot against gas molecules, ionizing released gas. Gas plus ions generated by this ionization are shot against the cathode that is formed of a titanium plate and use their energy to sputter titanium. Thereupon, an active titanium film is formed on the surface of the anode. Then, neutral molecules in the released gas and excited molecules land and adsorb on the titanium film and are exhausted. By this exhaust operation of the SIP, the interior of the vacuum envelope of the display device can be kept at a high degree of vacuum of 10⁻⁵ Pa or less.

In order to increase the probability of electrons being shot against gas molecules in the SIP, the magnetic field is formed by the permanent magnet that is located outside the pump container, and a free processing orbit of electrons is lengthened. The magnitude of the magnetic field influences the exhaust speed of the pump. The stronger the magnetic field, the higher the exhaust speed is. If permanent magnets of the same properties are used, the shorter the opening distance of the magnets, the less the magnetic field in the electrodes is.

If the pump container in the SIP described above is formed of a metal, the pump container itself can be set at the same potential as the cathode, so that the cathode can be arranged on the inner surface of the pump container. However, a gap corresponding to the wall thickness of the pump container is formed between the cathode and the permanent magnet, so that the opening distance of the permanent magnet lengthens correspondingly, thereby lowering the exhaust efficiency. If a C-shaped magnet is used as the permanent magnet, its opening portion is not magnetically shielded, so that magnetic field leakage from the opening portion is caused. Therefore, the SIP is not suited for combination with a device that is affected by leaked magnetic fields. Further, the permanent magnet is large, so that the pump mounting operation is poor in workability and stability, and miniaturization of the entire display device is hindered.

### BRIEF SUMMARY OF THE INVENTION

The present invention has been made in consideration of these circumstances, and its object is to provide a small-sized sputter ion pump with high exhaust efficiency, a manufacturing method therefor, and an image display device provided with the sputter ion pump.

In order to achieve the object, a sputter ion pump according to an aspect of the invention is characterized by comprising: a pump container; a cathode and an anode opposed to each other in the pump container; and a permanent magnet located in the pump container and situated between the cathode and the inner surface of the pump container.

According to another aspect of the invention, there is provided a method of manufacturing a sputter ion pump which comprises a pump container, a cathode and an anode opposed to each other in the pump container, and a permanent magnet located in the pump container and situated between the cathode and the inner surface of the pump container, the manufacturing method of a sputter ion pump comprising: locating the anode, cathode, and magnetic material in the pump container and then magnetizing the magnetic material from outside the pump container, thereby forming the permanent magnet.

An image display device according to another aspect of the invention is characterized by comprising: a vacuum envelope which includes a front substrate having a phosphor screen and a rear substrate provided with a plurality of electron emission sources which excite the phosphor screen and is kept with a vacuum inside; and a sputter ion pump connected to the vacuum envelope and configured to exhaust the vacuum envelope,

the sputter ion pump comprising a pump container connected to the vacuum envelope and having a vacuum inside, a cathode and an anode opposed to each other in the pump container, and a permanent magnet located in the pump container and situated between the cathode and the inner surface of the pump container.

According to the SIP constructed in this manner, the permanent magnet can be located adjacent to the cathode by being provided in the pump container. Thus, the opening distance of the permanent magnet can be reduced to increase the exhaust speed, thereby maximizing the exhaust efficiency. Further, the permanent magnet need not be provided outside the pump container, so that the pump can be miniaturized, and the assembly workability can be improved. If at least a part of the pump container is formed of a magnetic material, moreover, the pump container can form a closed magnetic circuit to shield leaked magnetic fields.

According to the image display device provided with the SIP described above, furthermore, the interior of the vacuum envelope can be kept at a high degree of vacuum by the SIP, so that a stable display quality level can be maintained for a long time.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an FED according to a first embodiment of this invention;

FIG. 2 is a sectional view of the FED taken along line II-II of FIG. 1;

FIG. 3 is a sectional view showing an SIP in the FED;

FIG. 4 is a sectional view schematically showing closed magnetic paths in the SIP;

FIG. 5 is a sectional view showing a forming process for the SIP;

FIG. 6 is a plan view showing the forming process for the SIP;

FIG. 7 is a sectional view showing an FED according to a second embodiment of this invention;

FIG. 8 is a sectional view showing the SIP of the second embodiment;

FIG. 9 is a sectional view schematically showing closed magnetic paths in the SIP;

FIG. 10 is a sectional view showing a forming process for the SIP; and

FIG. 11 is a plan view showing the forming process for the SIP.

### DETAILED DESCRIPTION OF THE INVENTION

An embodiment wherein an image display device with an SIP is applied to an FED will now be described in detail with reference to the drawings.

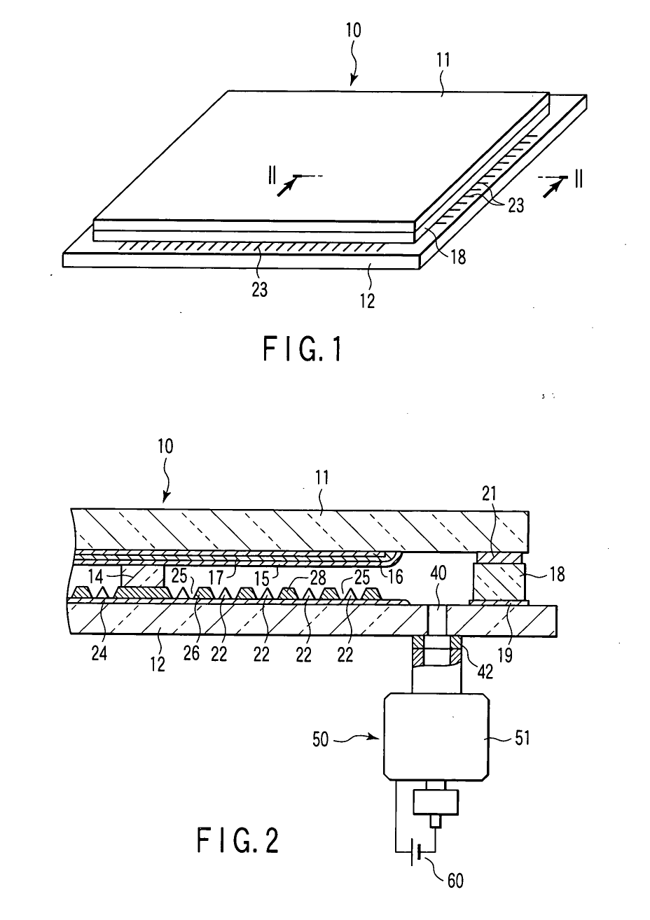

As shown in FIGS. 1 and 2, the FED comprises a front substrate 11 and a rear substrate 12, which are formed of a rectangular glass sheet each. These substrates are opposed to each other across a gap of about 1 to 2 mm. The rear substrate 12 is formed larger than the front substrate 11. The front substrate 11 and the rear substrate 12 have their respective peripheral edge portions joined together by a sidewall 18 in the form of a rectangular frame, and constitute a flat, rectangular vacuum envelope 10 that is kept in a vacuum inside.

A plurality of plate shaped support members 14 are arranged in the vacuum envelope 10 in order to support atmospheric load that acts on the front substrate 11 and the rear substrate 12. These support members 14 individually extend parallel to one side of the vacuum envelope 10 and are arranged at given spaces along a direction perpendicular to the one side. The support members 14 are not limited to the plate shape, and columnar ones may be used instead.

A phosphor screen 16 that functions as an image display surface is formed on the inner surface of the front substrate 11. The phosphor screen 16 is formed by arranging red, green, and blue phosphor layers and a light absorbing layer situated between these phosphor layers. The phosphor layers extend parallel to the one side of the vacuum envelope 10 and are arranged at given spaces along a direction perpendicular to the one side. A metal back 17 of, e.g., aluminum and a getter film 15 are successively formed on the phosphor screen 16.

A large number of electron emitting elements 22 are arranged on the inner surface of the rear substrate 12. They serve as electron emitting sources that excite the phosphor layers of the phosphor screen 16. These electron emitting elements 22 are arranged in a plurality of columns and a plurality of rows corresponding to individual pixels. More specifically, an electrically conductive cathode layer 24 is formed on the inner surface of the rear substrate 12, and a silicon dioxide film 26 having a large number of cavities 25 are formed on the electrically conductive cathode layer. Gate electrodes 28 of molybdenum, niobium or the like are formed on the silicon dioxide film 26. On the inner surface of the rear substrate 12, the cone-shaped electron emitting elements 22 of molybdenum or the like are provided in the cavities 25, individually. A large number of wires 21 that supply potential to the electron emitting elements 18 are provided in a matrix on the inner surface of the second substrate 12, and their end portions are drawn out to the peripheral edge portions of the vacuum envelope 15.

In the FED constructed in this manner, video signals are applied to the electron emitting elements 22 and the gate electrodes 28 that are formed in a simple matrix. A gate voltage of +100V for example is applied to the electron emitting elements 22 as a reference when in a highest-luminance state. Further, +10 kV for example is applied to the phosphor screen 16. Thereupon, electron beams are emitted from the electron emitting elements 22. The electron beams emitted from the electron emitting elements 22 are modulated in size by the voltage of the gate electrodes 28. These electron beams excite the phosphor layers of the phosphor screen 16 to luminescence, thereby displaying an image.

Since high voltage is applied to the phosphor screen 16 in this manner, high-strain glass is used as plate glass for the front substrate 11, rear substrate 12, sidewall 18, and support member 14. A space between the rear substrate 12 and the sidewall 18 is sealed with low-melting glass 19 such as fritted glass. A space between the front substrate 11 and the sidewall 18 is sealed with a sealing layer 21 that contains, for example, indium (In) as an electrically conductive low-melting sealing material.

In the vacuum envelope 10, an exhaust port 40 is formed in an end portion of the rear substrate 12. This exhaust port is connected with an SIP 50 that evacuates the interior of the vacuum envelope. The SIP 50 has a pump container 51 that is formed of a metal as a magnetic material, e.g., Fe/Ni alloy. The pump container 51 is bonded to the rear substrate 12 of the vacuum envelope 10 with fritted glass 42, communicates with the interior of the vacuum envelope through the exhaust port 40, and is kept with a vacuum inside. The pump container 51 is not limited to the case where its entire body is formed of a magnetic material. Only a part of it may be formed of the magnetic material if it can form a closed magnetic path, as mentioned later.

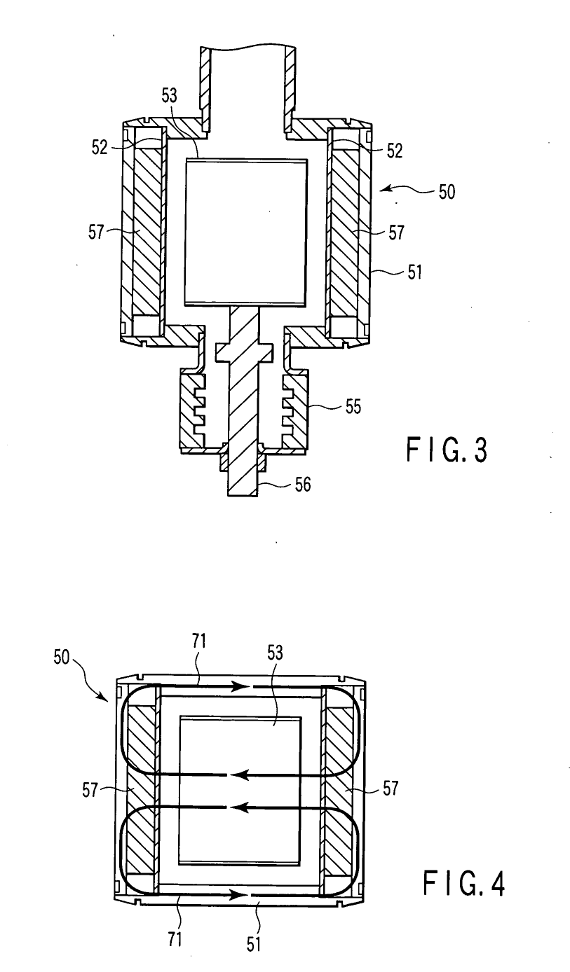

As shown in FIGS. 2 to 4, a cylindrical anode 53 is provided in the central part of the interior of the pump container 51. Plate-shaped cathodes 52 are located individually on the opposite opening sides of the anode and face the anode with given gaps between them. Each cathode 52 is formed of titanium or tantalum, for example. A plate-shaped permanent magnet 57 is provided between the inner surface of the pump container 51 and each cathode 52. The permanent magnet 57 is in contact with the substantially entire surface of the cathode 52 as it is fixed to the cathode and the inner surface of the pump container. The cathodes 52 are fixed to the pump container 51 by the permanent magnets 57. A relatively negative voltage is applied from a power source 60 to the cathodes 52.

An insulator 55 is attached to the lower end portion of the pump container 51, and an electrode 56 is supported by the insulator 55. The electrode 56 is drawn into the pump container 51 and connected to the anode 53. A relatively positive voltage is applied from the power source 60 to the anode 53 through the electrode 56.

According to the SIP constructed in this manner, a high voltage of 3 to 5 kV from the power source 60 is applied between the cathodes 52 and the anode 53 in a manner such that a magnetic field perpendicular to the cathodes 52 is applied by the permanent magnets 57 during operation. Thereupon, electrons are shot against gas molecules, ionizing released gas in the pump container 51. Gas plus ions generated by this ionization are shot against the cathodes 52 that are formed of, e.g., titanium plates, and use their energy to sputter titanium. Thereupon, an active titanium film is formed on the surface of the anode 53. Then, neutral molecules in the released gas and excited molecules land and adsorb on the titanium film and are exhausted. By this exhaust operation of the SIP 50, the released gas in the vacuum envelope 10 is discharged to keep the interior of the vacuum envelope at a high degree of vacuum of 10⁻⁵ Pa or below.

As shown in FIG. 4, the pump container 51 of the magnetic material, cathodes 52, and permanent magnets 57 form closed magnetic paths 71, and the magnetic field generated by the permanent magnets passes through the closed magnetic paths without leaking to the outside.

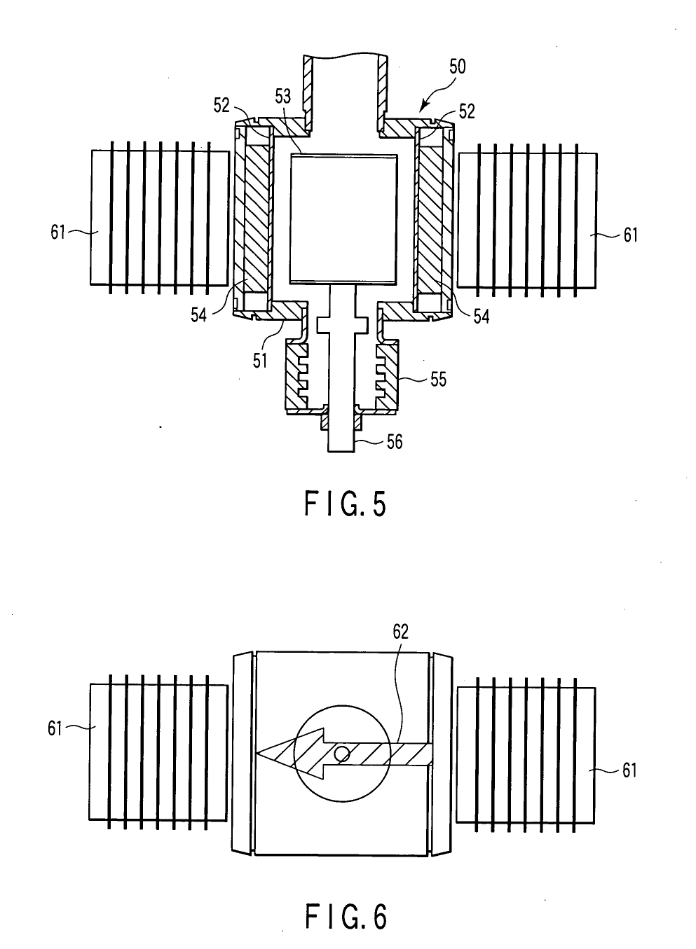

The SIP 50 constructed in this manner is manufactured by the following manufacturing method. As shown in FIGS. 5 and 6, the anode 53, the cathodes 52, and plate-shaped magnetic members 54 fixed individually to the cathodes are first individually located in the pump container 51, and the insulator 55 and the electrode 56 are attached to the pump container. Subsequently, the pump container 51 is connected to the vacuum envelope 10, and the pump container is kept with a vacuum inside. Thereafter, a pair of magnetizing coils 61 are located outside the pump container 51 and adjacently opposed to the magnetic members 54, individually. In this state, the magnetic members 54 are magnetized from outside the pump container 51 by the magnetizing coils 61. Thereupon, the magnetic members 54 become the permanent magnets 57 that generate a magnetic field 62 perpendicular to the cathodes 52. In these processes, the SIP 50 is formed connected to the vacuum envelope of the FED.

According to the SIP constructed in this manner, the permanent magnets 57 are provided in the pump container 51 and located adjacent to the cathodes 52. Therefore, the opening distance of the permanent magnets 57 can be made less than in the case where the permanent magnets are provided outside the pump container 51. Thus, the exhaust speed of the SIP 50 can be increased to maximize the exhaust efficiency. Further, the permanent magnets 57 need not be provided outside the pump container 51, so that the pump can be miniaturized, and the assembly workability can be improved.

Since at least a part of the pump container 51 is formed of the magnetic material, the pump container, permanent magnets, and cathodes can form the closed magnetic circuit to shield leaked magnetic fields. Thus, a great effect is produced when the SIP is used in combination with a device that is affected by leakage magnetism.

According to the SIP manufacturing method described above, a small-sized SIP can be easily formed by obtaining the permanent magnets by magnetizing the magnetic material, which is previously provided in the pump container 51, from outside the pump container.

According to the FED, moreover, the interior of the vacuum envelope 10 can be kept at a high degree of vacuum by the SIP 50, so that a stable display quality level can be maintained for a long time.

The following is a description of an FED according to a second embodiment of this invention. Like reference numerals are used to designate the same portions as those of the first embodiment, and a detailed description of them is omitted herein.

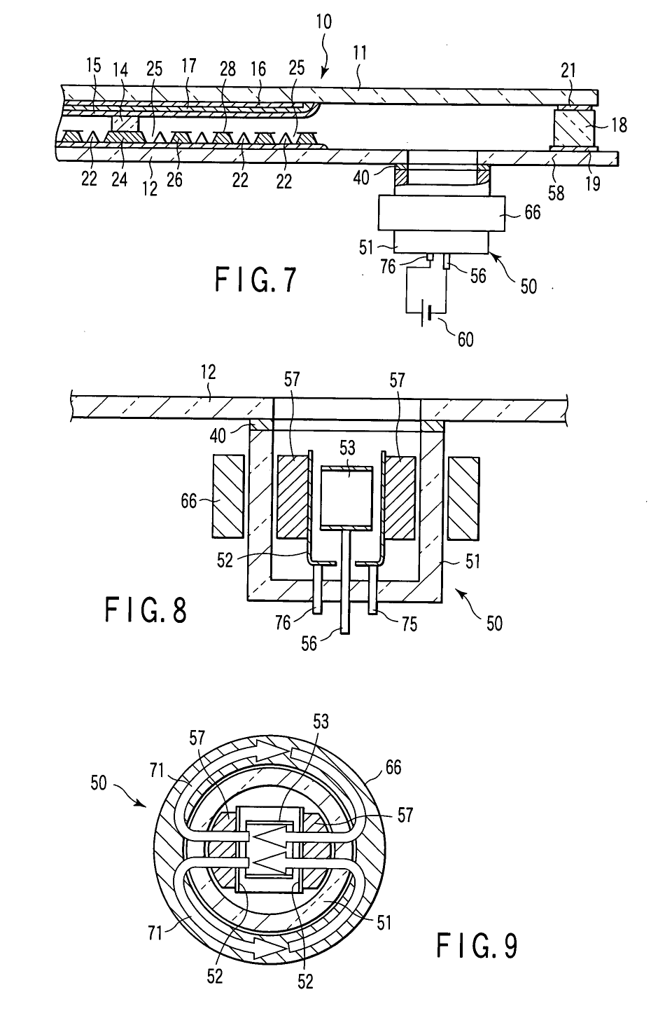

As shown in FIGS. 7 to 9, a rear substrate 12 of a vacuum envelope 10 is provided with a SIP 50 that discharges released gas from the vacuum envelope 10. The SIP 50 has a pump container 51 that is formed of a nonmetal, e.g., glass. In the present embodiment, the pump container 51 is bonded to the rear substrate 12 of glass with fritted glass 40, internally communicates with the interior of the vacuum envelope, and is kept with a vacuum inside.

A pair of cathodes 52 and an anode 53 are located in the pump container 51. The cathodes 52 are formed by bending metal plates of titanium or tantalum into a substantially U-shaped profile and are opposed to each other with a given space between them. These cathodes 52 are individually fixed to the pump container 51 by a nonpenetrating terminal 75 and a penetrating terminal 76. The anode 53 is located between the pair of cathodes 52 and opposed to the cathodes 52 with given gaps between them. The anode 53 is supported in the pump container 51 by an electrode 56. A relatively negative voltage and a relatively positive voltage are applied from a power source 60 outside the vacuum envelope 10 to the cathodes 52 and the anode 53 through the penetrating terminal 76 and the electrode 56, respectively.

A pair of permanent magnets 57 are provided in the pump container 51 and individually located between the inner surface of the pump container 51 and the cathodes 52. Each permanent magnet 57 is in contact with the substantially entire surface of the cathode 52 as it is fixed to the cathode. A magnetic body in the shape of a closed loop, e.g., an annular magnetic body 66, is mounted outside the pump container 51 and faces the permanent magnets 57. The magnetic body 66, along with the cathodes 52 and the permanent magnets 57, forms closed magnetic paths 71.

According to the SIP constructed in this manner, a high voltage of 3 to 5 kV from the power source 60 is applied between the cathodes 52 and the anode 53 in a manner such that a magnetic field perpendicular to the cathodes 52 is applied by the permanent magnets 57 during operation. Thereupon, electrons are shot against gas molecules, ionizing released gas in the pump container 51. Gas plus ions generated by this ionization are shot against the cathodes 52 that are formed of, e.g., titanium plates, and use their energy to sputter titanium. Thereupon, an active titanium film is formed on the surface of the anode 53. Then, neutral molecules in the released gas and excited molecules land and adsorb on the titanium film and are exhausted. By this exhaust operation of the SIP 50, the released gas in the vacuum envelope 10 is discharged to keep the interior of the vacuum envelope at a high degree of vacuum of 10⁻⁵ Pa or below.

As shown in FIG. 9, the magnetic body 66, cathodes 52, and permanent magnets 57 form the closed magnetic paths 71, and the magnetic field generated by the permanent magnets passes through the closed magnetic paths without leaking to the outside.

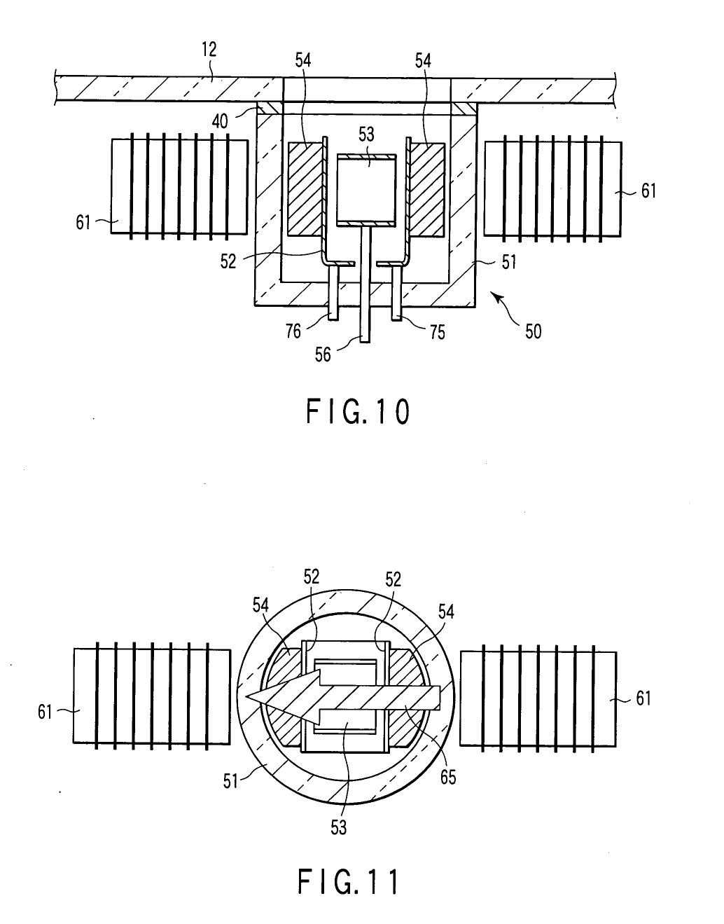

The SIP 50 constructed in this manner is manufactured by the following manufacturing method. As shown in FIGS. 10 and 11, the pump container 51, in which the anode 53, the cathodes 52, and the magnetic members 54 fixed to the cathodes 52 are arranged, is first bonded to the rear substrate 12 with the fritted glass 40.

Subsequently, the rear substrate 12, front substrate 11, and sidewall 18 are assembled to form the vacuum envelope 10 with a vacuum inside. At the same time, the pump container 51 is evacuated. Thereafter, a pair of magnetizing coils 61 are located outside the pump container 51 and adjacently opposed to the magnetic members 54, individually. In this state, the magnetizing coils 61 apply an electric field to the magnetic members 54 to magnetize them from outside the pump container 51. Thereupon, the magnetic members 54 become the permanent magnets 57 that generate a magnetic field 65 perpendicular to the cathodes 52. Thereafter, the annular magnetic body 66 is mounted outside the pump container 51. In these processes, the SIP 50 is formed connected to the vacuum envelope of the FED.

According to the SIP 50 constructed in this manner, the permanent magnets 57 are provided in the pump container 51 and located adjacent to the cathodes 52. Therefore, the opening distance of the permanent magnets 57 can be made less than in the case where the permanent magnets are provided outside the pump container 51. Thus, the exhaust speed of the SIP 50 can be increased to maximize the exhaust efficiency. The permanent magnets 57 need not be provided outside the pump container 51, so that the pump can be miniaturized, and the assembly workability can be improved.

The magnetic body in the shape of a closed loop is provided outside the pump container 51, and forms the closed magnetic paths 71 in cooperation with the permanent magnets 57 and the cathodes 52, so that leaked magnetic fields can be shielded. Thus, a great effect is produced when the SIP 50 is used in combination with a device that is affected by leakage magnetism.

According to the SIP manufacturing method described above, a small SIP can be easily formed by obtaining the permanent magnets by magnetizing the magnetic material, which is previously provided in the pump container 51, from outside the pump container.

According to the FED, moreover, the interior of the vacuum envelope 10 can be kept at a high degree of vacuum by the SIP 50, so that a stable display quality level can be maintained for a long time. As this is done, the assemblability can be improved and the entire device can be miniaturized by using a part of the vacuum envelope 10 to form the pump container 51 of the SIP 50, e.g., by molding the pump container integrally with the rear substrate.

The present invention is not limited directly to the embodiment described above, and its components may be embodied in modified forms without departing from the scope or spirit of the invention. Further, various inventions may be made by suitably combining a plurality of components described in connection with the foregoing embodiments. For example, some of the components according to the foregoing embodiment may be omitted. Furthermore, components according to different embodiments may be combined as required.

In the foregoing embodiments, the pump container is formed of a dedicated container for an SIP that is provided with an electrode outlet portion. Alternatively, for example, a part of a metallic vacuum envelope may be formed of a magnetic material to form a pump container of an SIP. Also in this case, the same function and effect as those of the foregoing embodiments can be obtained. In the foregoing embodiments, moreover, the magnetic body is provided to form the closed magnetic paths. Even if this magnetic body is omitted, however, the SIP with high exhaust efficiency can be obtained. The shapes, materials, etc., of the components of the SIP are not limited to those of the foregoing embodiments but may be variously selected as required.

Although the electron emitting elements used are of the field-emission type, they may alternatively be replaced with any other electron emitting elements, such as pn-type cold-cathode devices or surface-conduction electron emitting elements.

What is claimed is:

1. A sputter ion pump comprising:
a pump container;
a cathode and an anode opposed to each other in the pump container; and
a permanent magnet located in the pump container and situated between the cathode and the inner surface of the pump container.

2. The sputter ion pump according to claim 1, wherein the permanent magnet is in contact with or fixed to the cathode.

3. The sputter ion pump according to claim 1, wherein the pump container is formed of a metal.

4. The sputter ion pump according to claim 3, wherein at least a part of the pump container is formed of a magnetic material.

5. The sputter ion pump according to claim 1, wherein the pump container is formed of a nonmetal.

6. The sputter ion pump according to claim 5, wherein the pump container is formed of glass.

7. The sputter ion pump according to claim 5, wherein a magnetic body in the shape of a closed loop which defines a closed magnetic path is provided outside the pump container so as to face the permanent magnet.

8. A method of manufacturing a sputter ion pump which comprises a pump container, a cathode and an anode opposed to each other in the pump container, and a permanent magnet located in the pump container and situated between the cathode and the inner surface of the pump container, the manufacturing method of a sputter ion pump comprising:
locating the anode, cathode, and magnetic material in the pump container and then magnetizing the magnetic material from outside the pump container, thereby forming the permanent magnet.

9. The manufacturing method for a sputter ion pump according to claim 8, wherein the magnetic material is magnetized with the pump container evacuated inside.

10. An image display device comprising:
a vacuum envelope which includes a front substrate having a phosphor screen and a rear substrate provided with a plurality of electron emission sources which excite the phosphor screen and is kept with a vacuum inside; and
a sputter ion pump connected to the vacuum envelope and configured to exhaust the vacuum envelope,
the sputter ion pump comprising a pump container connected to the vacuum envelope and having a vacuum inside, a cathode and an anode opposed to each other in the pump container, and a permanent magnet located in the pump container and situated between the cathode and the inner surface of the pump container.

11. The image display device according to claim 10, wherein the permanent magnet is in contact with or fixed to the cathode.

12. The image display device according to claim 11, wherein the pump container is formed of a metal.

13. The image display device according to claim 12, wherein at least a part of the pump container is formed of a magnetic material.

14. The image display device according to claim 11, wherein the pump container is formed of a nonmetal.

15. The image display device according to claim 14, wherein the pump container is formed of glass.

16. The image display device according to claim 14, wherein a magnetic body in the shape of a closed loop which forms a closed magnetic path is provided outside the pump container so as to face the permanent magnet.

17. The image display device according to claim 11, wherein the pump container is formed by molding a part of the rear substrate.
